(19) United States
(12) Patent Application Publication
(10) Pub. No.: US 2024/0054221 A1
(43) Pub. Date: Feb. 15, 2024

(54) Trusted Computing Service Directory

(71) Applicant: Telefonaktiebolaget LM Ericsson (publ), Stockholm (SE)

(72) Inventors: Jari Arkko, Kauniainen (FI); Jimmy Kjällman, Espoo (FI)

(21) Appl. No.: 18/258,086

(22) PCT Filed: Nov. 12, 2021
(86) PCT No.: PCT/EP21/81526

§ 371 Date: Jun. 16, 2023

Related U.S. Application Data
(60) Provisional application No. 63/129,040, filed on Dec. 22, 2020.

(51) Int. Cl. G06F 21/57; G06F 21/60; G06F 21/64

(52) U.S. Cl. CPC G06F 21/57; G06F 21/602; G06F 21/64

(57) ABSTRACT

Embodiments include methods performed by a computing device to obtain trusted computing services (TCS) from service providers (SPs). Such methods include querying one or more remote service databases for one or more TCS required by a user of the computing device or by an application executing on the computing device. The query for each required TCS includes identification of software required to provide the required TCS, and one or more indicia of trust for any computing platform that provides the required TCS. Such methods include receiving, from the remote service databases, information related to one or more available TCS and corresponding SPs of the available TCS and, based on the received information, selecting one of the available TCS and establishing a connection with the SP corresponding to the selected TCS. Embodiments include complementary methods performed by SPs and remote service databases, as well as apparatus configured to perform such methods.

### TECHNICAL FIELD

The present application relates generally to the field of trusted computing, and more specifically to techniques for matching users' trusted computing requirements with available trusted computing services, including associated software and trusted computing parameters, and techniques for discovering available trusted computing services that are compatible with such requirements.

### BACKGROUND

In general, “cloud computing” refers to the delivery of remote computing services such as application servers, storage, databases, networking, analytics, and intelligence to users over the Internet. “Cloud” infrastructure” generally refers to the hardware and software components such as servers, storage, networking, etc., that are needed to support the computing requirements of a cloud computing model. Cloud infrastructure also typically includes an abstraction layer that virtualizes the hardware resources and logically presents them to users (e.g., as “virtual machines”) through application program interfaces (APIs). Such virtualized resources are typically hosted by a service provider are delivered to users over the public Internet or a private network. Publicly available cloud infrastructure can be referred to as “infrastructure as a service”. Cloud infrastructure is typically built on top on large scale commodity servers, typically based on the well-known Intel x86 architecture used in personal computing.

Cloud technology has swiftly transformed information and communications technology (ICT) and it is continuing to spread to new areas. Many traditional ICT applications, such as web-based services, are suitable for cloud deployment in that they have relaxed timing or performance requirements. These services are typically based on HyperText Transport Protocol (HTTP) signaling. A common platform used to provide cloud-based web-services is Kubernetes, which can coordinate a highly available cluster of connected computers (also referred to as “processing elements” or “hosts”) to work as a single unit. Kubernetes deploys applications packaged in “containers” (e.g., via its “container runtime”) to decouple them from individual computing hosts. These Kubernetes abstractions facilitate deploying applications to a cloud-based computing cluster without tying them specifically to individual computing machines. In this manner, containerized applications are more flexible and available than in deployment modes where applications were installed directly onto specific machines. Such containerized applications are referred as “cloud-native” applications.

Many common Internet services are provided via cloud computing infrastructure. One example is the Domain Name System (DNS), which is a hierarchical and decentralized naming system for computers, services, or other resources connected to the Internet or a private network. DNS associates various information with various domain names assigned to participating entities. Most prominently, DNS translates more readily memorized domain names (e.g., ericsson.com) to numerical Internet Protocol (IP) addresses needed for locating and identifying computing services and infrastructure via the underlying network protocols.

By providing a worldwide, distributed directory service, DNS has been an essential component of the Internet since 1985. However, DNS has seen a relatively slow pace of technical change. Most queries to the DNS are still made through the original user datagram protocol (UDP) port 53 protocol to a DNS resolver that typically resides in a local Internet Service Provider (ISP). A fraction of DNS queries is made through global services, including so-called “Quad-N” services such as Google's 8.8.8.8. These services provide a high-quality, globally-available DNS resolution service that typically does not perform any local filtering except where mandated by the home location (e.g., government) of these services themselves.

Internet services are generally provided “as is”, without any guarantees of security, privacy, etc. for users. Taking the example of DNS, a DNS resolver service might sell a user's DNS query history (e.g., from web browsing) to other parties. Likewise, even services purported as secure or private can be executed on insecure computing platforms susceptible to hacking and theft of sensitive user information (e.g., credit cards, financial data, etc.).

Trusted computing can provide technical solutions to improve security of Internet services running on remote (e.g., cloud) computing infrastructure. With trusted computing, a computer will consistently behave in ways expected by the user. Moreover, those behaviors will be enforced by hardware and software, such as by loading the hardware with a unique encryption key inaccessible to the rest of the computing infrastructure. Trusted computing can also protect user information from owners of cloud computing infrastructure. For example, it can be advantageous that an infrastructure owner has no “super-powers” to observe, measure, etc. the user processes that are executing on the constituent computing machines.

Attestation is an important concept of trusted computing. A process can attest to one or more facts about itself, e.g., that it executes on a particular type of CPU, a specific software image is being executed, etc. An attestation can be sent to a remote party that wants to ensure that specific software is running on trusted computing hardware. In general, attestation depends on a trust chain, such as the user trusting a CPU manufacturer, who trusts that a key loaded into a particular CPU is valid and that the CPU signs an attestation using that key.

### SUMMARY

Conventional mechanisms for trusted computing primarily benefit computing infrastructure owners and/or application owners, rather than end users. Cloud computing frameworks can set up trusted computing based on knowledge of compatible hardware to support it. Application owners can request specific trusted computing capabilities from the particular cloud infrastructure on which the application executes (e.g., AWS).

In general, however, it is not possible for users to demand or find a service with specific trusted computing and/or software settings. As a more concrete example, there are currently no solutions that enable a user to find a DNS resolver running specific software running inside a trusted computing environment.

Accordingly, embodiments of the present disclosure address these and other problems, issues, and/or difficulties with trusted computing in a cloud environment, such as by matching users' trusted computing requirements with offered trusted computing services and/or by facilitating discovery of offered trusted computing services that are compatible with user requirements.

Some embodiments include exemplary methods (e.g., procedures) for a computing device to obtain trusted computing services (TCS) from service providers (SPs). These exemplary methods can be performed by a computing device (e.g., desktop, laptop, smartphone, tablet, wireless device, user equipment, IoT device, etc.).

These exemplary methods can include querying one or more remote service databases for one or more TCS required by a user of the computing device or by an application executing on the computing device. The query for each of the required TCS can include identification of software required to provide the required TCS, and one or more indicia of trust for any computing platform that provides the required TCS. These exemplary methods can also include receiving, from the one or more remote service databases, information related to one or more available TCS and corresponding SPs of the available TCS. These exemplary methods can also include, based on the received information, selecting one of the available TCS and establishing a connection with the SP corresponding to the selected TCS.

In some embodiments, the identification of software in the query for each required TCS can include one of the following: a hash value of a software image and of all associated configuration data; or an indication of a third party that can sign a statement that a particular software image and configuration data is acceptable for the required TCS.

In some embodiments, the query for each required TCS can include a human-readable service name associated with the required TCS, and the identification of software in the query for each required TCS can include a location from which the software can be obtained.

In some embodiments, the indicia of trust in the query for each required TCS include one or more of the following:
roots of trust from a manufacturer of CPUs trusted to perform the required TCS;
one or more types of computing technology trusted to perform the required TCS;
one or more types of computing technology not trusted to perform the required TCS; and
features that must be enabled or disabled for trusting a computing platform to perform the required TCS.

In some of these embodiments, the one or more types of computing technology trusted to perform the required TCS can include any of the following: Intel Software Guard eXtensions (SGX), AMD Secure Encrypted Virtualization (SEV), and ARM TrustZone.

In some embodiments, the query for each required TCS can include a requirement for the required TCS to be single-user, a requirement for the required TCS to be multi-user, or an indication that the required TCS can be single-user or multi-user.

In some embodiments, these exemplary methods can also include querying one or more first remote databases for information concerning further remote databases of available TCS and receiving, from the one or more first databases, addresses of the one or more remote service databases. In some embodiments, the computing device can be preconfigured with addresses of the one or more first remote databases. The received addresses can be used, for example, for the subsequent query.

In some of these embodiments, the one or more first remote databases can be associated with respective domain names and domain name service (DNS) resolvers. In some of these embodiments, the one or more remote service databases can also be associated with respective domain names and DNS resolvers.

In some embodiments, these exemplary methods can also include: receiving, from the selected TCS via the established connection, a cryptographic attestation associated with software and/or computing platform used for the selected TCS; and based on verifying the cryptographic attestation is valid and meets requirements provided in the query, obtaining the selected TCS via the software and/or the computing platform associated with the cryptographic attestation.

In some of these embodiments, these exemplary methods can also include receiving, from the selected TCS, third-party information associated with the software used for the selected TCS. For example, the third-party information can be a digital signature indicating that a particular version of the software is acceptable for the selected TCS. In these embodiments, the obtaining operations can also be based on verifying that the third party is trusted and the third-party information is valid.

In other of these embodiments, the received information related to a first TCS of the available TCS includes an indication that the first TCS is willing to run any user-provided software, and trusted computing parameters associated with a computing platform used to run any user-provided software. In such embodiments, the selecting and establishing can include selecting the first TCS based on the indication that the first TCS is willing to run any user-provided software; and sending one of the following to the first TCS via the connection: a software image and all associated configuration data; or an indication of a trusted location from which the selected TCS can obtain a software image and all associated configuration data.

Other embodiments include exemplary methods (e.g., procedures) for a SP of TCS. These exemplary methods can be performed by a computing platform (e.g., processors executing software stored in memories) associated with the SP.

These exemplary methods can include sending, to a remote service database, the following information related to each of one or more TCS available from the SP: an identifier of the available TCS; identification of software used to provide the available TCS; and one or more indicia of trust for a computing platform used to provide the available TCS. These exemplary methods can also include receiving, from a computing device, an indication of selection of one of the available TCS by a user of the computing device or by an application executing on the computing device, and establishing a connection with the computing device.

In some embodiments, the identification of software for each available TCS can include one of the following: a hash value of a software image and of all associated configuration data; or an indication of a third party that can sign a statement that a particular software image and configuration data is acceptable for the available TCS.

In other embodiments, for each available TCS, the identifier of the available TCS includes a human-readable service name and the identification of the software can include a location from which the software can be obtained.

In some embodiments, the indicia of trust for each available TCS can include one or more of the following:
roots of trust from a manufacturer of CPUs used to provide the available TCS;
one or more types of computing technology used to provide the available TCS; and
features that are enabled or disabled in the computing platform used to provide the available TCS.
   In some of these embodiments, the one or more types of computing technology used to provide the available TCS includes any of the following: Intel SGX, AMD SEV, and ARM TrustZone.

In some embodiments, the information sent to the remote service database also includes one of the following for each available TCS: an indication that the available TCS can only be single-user, an indication that the available TCS can only be multi-user, or an indication that the available TCS can be single-user or multi-user.

In some embodiments, receiving the indication of a selection is via a first address. In such embodiments, these exemplary methods can also include: when an instance of the selected TCS is already running on the computing platform and a load level of the already-running instance is below a threshold, assigning the user computing device to the already-running instance; otherwise, initiating an instance of the selected TCS and assigning the user computing device to the initiated instance; and redirecting the connection from the first address to a second address associated with the assigned instance of the selected TCS.

In some embodiments, the remote service database can be associated with a domain name and a DNS resolver.

In some embodiments, these exemplary methods can also include: providing, by the selected TCS to the computing device via the connection, a cryptographic attestation associated with software and/or computing platform used for the selected TCS; and providing the selected TCS to the computing device via the software and/or the computing platform associated with the cryptographic attestation.

In some of these embodiments, these exemplary methods can also include providing, by the selected TCS to the user computing device via the connection, third-party information associated with the software used for the selected TCS. In some embodiments, the third-party information can be a digital signature indicating that a particular version of the software is acceptable for the selected TCS.

In other of these embodiments, the information related to a first TCS, of the available TCS, that is sent to the remote service database can include an indication that the first TCS is willing to run any user-provided software, and trusted computing parameters associated with a computing platform used to run any user-provided software. In such embodiments, the selected TCS can be the first TCS. In such case, these exemplary methods can also include obtaining a software image and all associated configuration data for the software used for the first TCS either directly from the user computing device via the connection or from a trusted location indicated by the user computing device. In such embodiments, the cryptographic attestation provided can be based on the obtained software image and all associated configuration data.

Other embodiments include exemplary methods (e.g., procedures) for a service database to match required TCS to available TCS. These exemplary methods can be performed by a service database (e.g., storage medium, associated processing and communications circuitry/software).

These exemplary methods can include receiving, from a plurality of SPs, the following information related to each of one or more TCS available from each of the SPs: an identifier of the available TCS; identification of software used to provide the available TCS; and one or more indicia of trust for a computing platform used to provide the available TCS. These exemplary methods can also include storing the information from the SPs (i.e., in a non-transitory storage medium). These exemplary methods can also include receiving a query for one or more TCS required by a user of a computing device or by an application executing on the computing device. The query for each of the required TCS can include identification of software required to provide the required TCS, and one or more indicia of trust for any computing platform that provides the required TCS.

These exemplary methods can also include identifying, from the stored information, one or more available TCS that corresponds to the information provided with the query. These exemplary methods can also include sending to the computing device in response to the query, an indication of the identified available TCS and corresponding SPs of the identified available TCS.

In some embodiments, the identification of software in the query for each required TCS can include one of the following: a hash value of a software image and of all associated configuration data; or an indication of a third party that can sign a statement that a particular software image and configuration data is acceptable for the required TCS.

In some embodiments, the query for each required TCS can include a human-readable service name associated with the required TCS, and the identification of software in the query for each required TCS can include a location from which the software can be obtained.

In some embodiments, the indicia of trust in the query for each required TCS include one or more of the following:
roots of trust from a manufacturer of CPUs trusted to perform the required TCS;
one or more types of computing technology trusted to perform the required TCS;
one or more types of computing technology not trusted to perform the required TCS; and
features that must be enabled or disabled for trusting a computing platform to perform the required TCS.
   In some of these embodiments, the one or more types of computing technology trusted to perform the TCS includes any of the following: Intel SGX, AMD SEV, and ARM TrustZone.

In some embodiments, the query for each required TCS can include a requirement for the required TCS to be single-user, a requirement for the required TCS to be multi-user, or an indication that the required TCS can be single-user or multi-user.

In some embodiments, the service database can be associated with a domain name and a DNS resolver.

In some embodiments, the identification of software for each available TCS can include one of the following: a hash value of a software image and of all associated configuration data; or an indication of a third party that can sign a statement that a particular software image and configuration data is acceptable for the available TCS.

In other embodiments, for each available TCS, the identifier of the available TCS can include a human-readable service name and the identification of the software can include a location from which the software can be obtained.

In some embodiments, the indicia of trust for each available TCS can include one or more of the following:
roots of trust from a manufacturer of CPUs used to provide the available TCS;
one or more types of computing technology used to provide the available TCS; and
features that are enabled or disabled in the computing platform used to provide the available TCS.
   In some of these embodiments, the one or more types of computing technology used to provide the available TCS includes any of the following: Intel SGX, AMD SEV, and ARM TrustZone.

In some embodiments, the received information related to each available TCS includes one of the following: an indication that the available TCS can only be single-user, an indication that the available TCS can only be multi-user, or an indication that the available TCS can be single-user or multi-user.

Other embodiments include computing devices, computing platforms, and service databases that are configured to perform the operations corresponding to any of the exemplary methods described herein. Other embodiments include non-transitory, computer-readable media storing computer-executable instructions that, when executed by processing circuitry, configure such computing devices, computing platforms, and service databases to perform operations corresponding to any of the exemplary methods described herein.

These and other embodiments described herein can enable a user or an application to find or launch services with specific software and trusted computing settings, such as a trusted computing-capable cloud service that is willing to execute a given software (or any software). More specifically, embodiments can facilitate finding a trusted computing-capable service instance that runs exactly the software that is desired, and the service instance can prove that it actually runs the software. As a more specific example, embodiments can facilitate a user to request (and desirably find) a TCS that supports a desired privacy level, such as a DNS resolver that cannot be used for commercial surveillance of the user's browsing history.

These and other objects, features, and advantages of the present disclosure will become apparent upon reading the following Detailed Description in view of the Drawings briefly described below.

### BRIEF DESCRIPTION OF THE DRAWINGS

FIG. 1 shows a high-level illustration of conventional DNS operation in an exemplary network.

FIG. 2 shows a high-level arrangement for using trusted computing to support secure workload execution on trusted hardware.

FIG. 3 illustrates an exemplary process of software attestation, which can be performed in the context of the arrangement shown in FIG. 2.

FIG. 4 shows a high-level arrangement that illustrates various embodiments of the present disclosure in the context of two SPs, a user or application needing a service (e.g., TCS), and a centralized (or remote) service database.

FIG. 5 illustrates an exemplary method (e.g., procedure) for a computing device, according to various embodiments of the present disclosure.

FIG. 6 illustrates an exemplary method (e.g., procedure) for a SP of TCS, according to various embodiments of the present disclosure.

FIG. 7 illustrates an exemplary method (e.g., procedure) for a service database of TCS, according to various embodiments of the present disclosure.

FIG. 8 shows a block diagram of an exemplary computing device or user equipment (UE), according to various embodiments of the present disclosure.

FIG. 9 is a block diagram of an exemplary computing platform that can be used by service providers of TCS and/or by a service database for TCS, according to various embodiments of the present disclosure.

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features and advantages of the disclosed embodiments will be apparent from the following description.

In the present disclosure, the term “service” is used generally to refer to a set of data, associated with one or more applications, that is to be transferred via a network with certain specific delivery requirements that need to be fulfilled in order to make the applications successful. In the present disclosure, the term “component” is used generally to refer to any component needed for the delivery of the service. Examples of components are cloud infrastructure with related resources such as computation and storage.

As briefly mentioned above, conventional mechanisms for trusted computing primarily benefit computing infrastructure owners and/or application owners, rather than end users. In general, it is not possible for users to demand or find a service with specific trusted computing and/or software settings. As a more concrete example, there are currently no solutions that enable a user to find a DNS resolver running specific software running inside a trusted computing environment. This is discussed in more detail below, using DNS as an illustrative example.

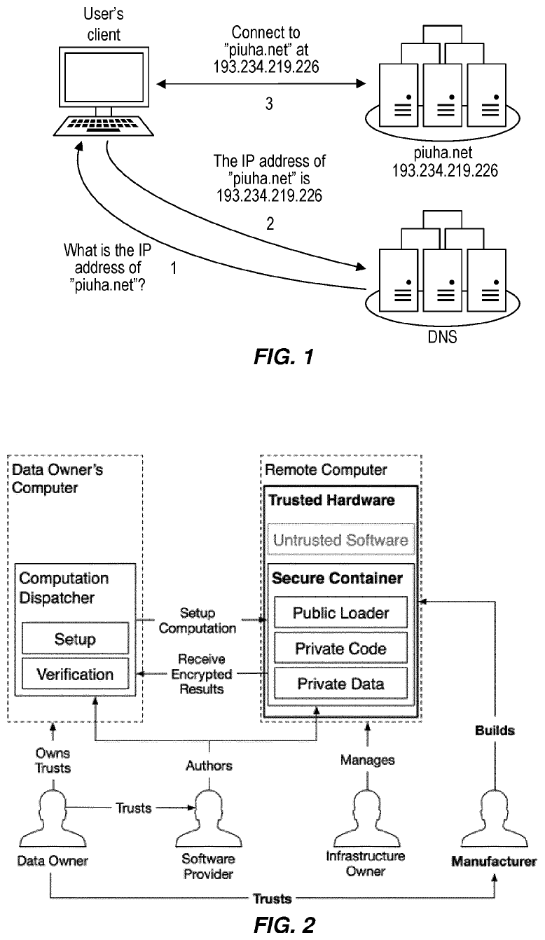

FIG. 1 shows a high-level illustration of conventional DNS operation in an exemplary network. Initially, a user enters an address that includes the domain name “piuha.net” into application client, such as a web browser, that runs on the user's computing client (e.g., laptop, cellular phone, etc.). In operation 1, the user's computing client sends a DNS query for the domain name towards a DNS server. The DNS server then translates the domain name “piuha.net” into an IP address, and returns that to the requesting computing client in operation 2. In operation 3, the computing client accesses the application server (e.g., web server) at the provided IP address. Within the DNS server, a component called “DNS resolver” is responsible for checking if the submitted domain name is available in a local cache and, if not, contacting a series of remote DNS servers until it eventually receives the requested IP address.

By providing a worldwide, distributed directory service, DNS has been an essential component of the Internet since 1985. However, DNS has seen a relatively slow pace of technical change. Most queries to the DNS are still made through the original user datagram protocol (UDP) port 53 protocol to the DNS resolver, which typically resides in a local Internet Service Provider (ISP). A small fraction of DNS queries (e.g., <10%) is made through global services, including so-called “Quad-N” services such as Google's 8.8.8.8. These services provide a high-quality, globally-available DNS resolution service that typically does not perform any local filtering except where mandated by the home location (e.g., government) of these services themselves. Even so, the Internet space is quite dynamic. For example, the two most popular web browsers have a roughly 80% market share. Adapting either or both of these browsers to use global DNS service(s) by default would quickly change the DNS landscape.

Recently, the Internet Engineering Task Force (IETF) developed new technology for DNS queries, including DNS-over-HTTPS (DoH, specified in RFC 8484) and DNS-over-TLS (DoT, specified in RFC 7858). These technologies allow queries to be performed confidentially, using modern and flexible web protocol frameworks. Since deployment of DoT/DoH requires updates to client operating systems (OS) and the many DNS resolvers deployed in ISP networks, uptake has been relatively slow. Even so, some browsers have adopted DoH, which is an HTTP-based service and as such a natural fit for browsers. Some browsers are considering DoH as a default DNS resolution mechanism, with the consequence of directing all queries to a DoH-based resolver.

Depending on the specific deployment models used, this can be a single resolver service within a geographical area or some small set of services. Moreover, this solution is relatively easy to deploy, since changes are only required in a browser (which are often subject to software updates) and the global services that are used. This has the potential for quick adoption, helping to avoid both localized result filtering and/or tampering with DNS queries.

The record of each user's DNS queries is sensitive information because it provides a history of websites the user has visited. The use of an encrypted DNS query protocol such as DoH helps keep this history private, both the from the ISPs and other interested parties. However, DoH offers no protection against lack of trust in the endpoints (i.e., DNS resolver and requesting client system). Moreover, centralizing all users' DNS queries to a relatively small number of resolvers—no matter how trustworthy—has other problems, issues, and/or drawbacks.

For example, a centralized service that handles information for a very large number of users becomes valuable from a commercial perspective, such that the controlling entity will be motivated to monetize that information based on data mining and selling to other parties. As another example, governments will be motivated to tap into the centralized service as a source of information for intelligence operations and/or pervasive surveillance. Although governments may not be able to easily compel millions of current DNS services to provide information, a centralized service under the control of one commercial entity in one jurisdiction becomes a much easier target, particularly if the commercial entity wants to maintain good relations with the requesting government.

Furthermore, the end user may not be aware of the particular jurisdiction in which the centralized service is hosted. Privacy laws and/or government surveillance laws and practices vary significantly across jurisdictions. Even though end users may have some ability to influence such laws and practices in their own jurisdictions, they have little or no ability to influence those in foreign jurisdictions.

These and other reasons cause the centralized service to become a potentially weak (or critical) point in the Internet. Although a centralized, encrypted DNS service provides some benefits, these may be outweighed by the drawbacks, except for users in jurisdictions in which local service providers perform excessive DNS filtering and/or surveillance.

One desirable solution is to have a trustworthy DNS provider. However, it is unclear how to objectively determine whether a DNS provide is sufficiently “trustworthy”. Furthermore, even if a user identifies such a DNS provides, it is unclear whether users will be able to specify this DNS provider in their browsers or other applications using DNS.

Another alternative is to use multiple DNS servers but only provide partial information to any one of them. However, this approach can be complex. A similar technique is known as Oblivious DNS (ODNS), which separates the knowledge of who is requesting and what is being requested between two different entities. This is possible by sending a query to first entity while encrypting it to a second entity. The first entity does not know what name is being queried. The first entity forwards the encrypted query to the other entity, which responds but is not aware of the source of the original query. However, this solution may have excess latency due to the forwarding.

There are also new ways of architecting DNS services so that they leak less information about the users who query them. This would reduce the main drawbacks of centralized systems for DNS resolution.

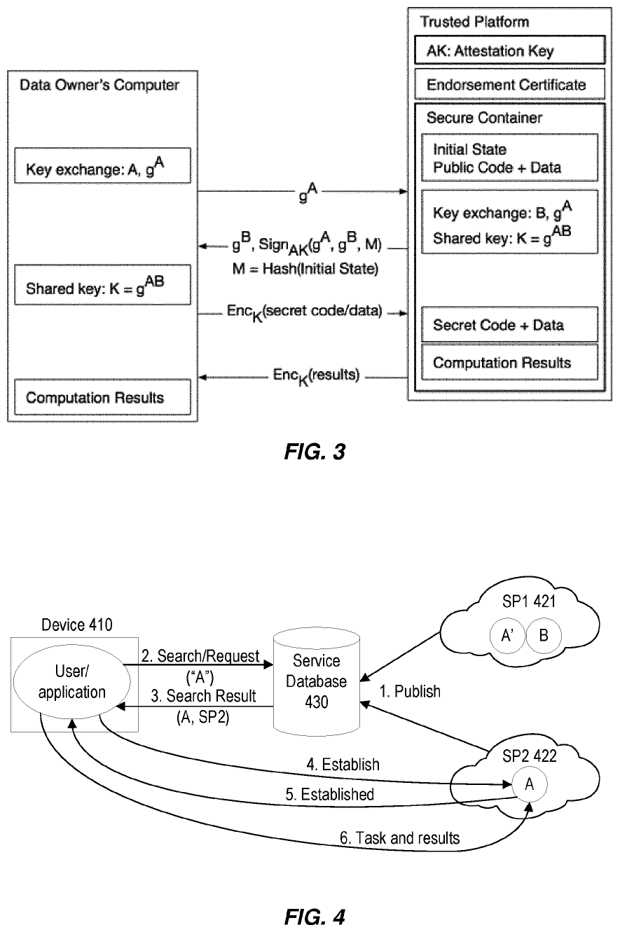

Additionally, trusted computing can be used for any service, including DNS. An important advantage of trusted computing is that a service or function can be protected from adversaries as well as an owner of the computing machine on which the service runs. FIG. 2 shows a high-level arrangement for using trusted computing to support secure workload execution on trusted hardware. The arrangement illustrates four different roles: data owner, software provider, infrastructure (i.e., machine or data center) owner, and hardware (e.g., CPU) manufacturer. The data owner establishes trust with the manufacturer and the software provider. The manufacturer provides the trusted hardware, which establishes a secure container into which the data owner (or service user) uploads the desired computation and data. The trusted hardware protects the data's confidentiality and integrity while the computation is being performed.

Attestation is an important concept of trusted computing. A process can attest to one or more facts about itself, e.g., that it executes on a particular type of CPU, a specific software image is being executed, etc. An attestation can be sent to a remote party that wants to ensure that specific software is running on trusted computing hardware. In general, attestation depends on a trust chain, such as the user trusting a CPU manufacturer, who trusts that a key loaded into a particular CPU is valid and that the CPU signs an attestation using that key.

FIG. 3 illustrates an exemplary process of software attestation, which can be performed in the context of the arrangement shown in FIG. 2. The attestation proof is a cryptographic signature that certifies the hash of the contents of a secure container on the remote computer. In other words, the remote computer's owner can load any software in a secure container, but the remote computation service user will refuse to load data into a secure container whose contents' hash does not match the expected value. The remote computation service user verifies the attestation key used to produce the signature against an endorsement certificate created by the trusted hardware's manufacturer. The certificate states that the attestation key is only known to the trusted hardware, and only used for the purpose of attestation.

In the process shown in FIG. 3, the trusted platform (i.e., CPU of the remote computer) takes a hash of its initial state (e.g., software and configuration). It then uses the Attestation Key (AK) to sign this state. The AK is trusted by the manufacturer, which can be realized, for instance, via a certificate (or signature) of the manufacturer. With a signature from the remote computer and another signature by its manufacturer, the data owner knows that, barring vulnerabilities in the CPU, the computations performed by the computer are safe from everyone, including any spying by the owner of the remote computer.

The data owner's Computer and the remote computer also establish a secure communications channel protected by key K. In FIG. 3, this is performed via a Diffie-Hellman key exchange, but other methods are also possible. A secure channel is necessary because otherwise any assurance by the remote computer about data privacy or faithful execution of the task would be worthless, since attackers could spy or change the data or results communicated between the data owner's computer and the remote computer.

Although FIGS. 2-3 illustrate attestation in the context of remote computing, similar techniques can be used in the context of networking equipment. For example, the networking platform identity can be based on IEEE 802.1AR Device Identity. Some applications with a more-complex post-manufacture supply chain (e.g., value-added resellers) or with specific privacy concerns may use an alternate mechanism for platform authentication. Attestation of mutable elements throughout the life of fielded devices can be implemented, to provide an authenticated mechanism to report what software actually starts up on the device each time it reboots. Additionally, Reference Integrity Measurements must be conveyed from the software authority (often the manufacturer for embedded systems) to the system in which verification will take place.

Intel's Software Guard eXtensions (SGX) is one implementation of trusted computing. SGX is designed for implementing secure remote computation, secure web browsing, and digital rights management (DRM). Other applications include concealment of proprietary algorithms and of encryption keys.

SGX is a set of security-related instruction codes that are built into some modern Intel central processing units (CPUs). They allow both user-level code and OS code to define private regions of memory (“enclaves”) whose contents are protected and unable to be either read or saved by any process outside the enclave itself, including processes running at higher privilege levels. SGX is disabled by default and must be enabled by a user through via CPU motherboard settings on a supported system.

SGX involves CPU encryption of a portion of memory constituting an enclave. The enclave is decrypted on the fly only within the CPU itself, and only for code and data running from within the enclave itself. The CPU thus protects the enclave code from being “spied on” or examined by other code outside the enclave. The code and data in the enclave utilize a threat model in which the enclave is trusted but no process outside it can be trusted (including the OS and any hypervisor), and therefore all of these are treated as potentially hostile. The enclave contents are unable to be read by any code outside the enclave, other than in its encrypted form. Applications running inside of SGX must be written to be side channel resistant, since SGX does not protect against side channel measurement or observation.

Trusted computing can provide technical solutions to improve security of Internet services running on remote (e.g., cloud) computing infrastructure. With trusted computing, a computer will consistently behave in ways expected by the user. Moreover, those behaviors will be enforced by hardware and software, such as by loading the hardware with a unique encryption key inaccessible to the rest of the computing infrastructure. Trusted computing can also protect user information from owners of cloud computing infrastructure. For example, it can be advantageous that an infrastructure owner has no “super-powers” to observe, measure, etc. the user processes that are executing on the constituent computing machines.

For example, AMD Secure Encrypted Virtualization (SEV) can be used for running whole Virtual Machines (VMs) in trusted execution environments. SEV can be used in conjunction with a compute service such as OpenStack Nova, which in that case maintains information about trusted computing-related capabilities of SEV-enabled compute nodes (i.e., VM hosts) registered to it. Users can specify that certain VM instances need to be launched on such nodes.

Similarly, there are some SGX device plugins that can be used in Kubernetes clusters for registering that certain worker nodes in a cluster support Intel SGX and have a certain total amount of Enclave Page Cache (EPC) memory. Users can specify that certain pods need to be scheduled on such nodes with a certain amount of available EPC memory.

In general, however, these and other existing cloud platform mechanisms are for users of a specific cloud farm, or a federated set of cloud farms. An application owner launches their processes with a specification that the application owner fully controls. Even if some small amount of negotiation is involved, the process is entirely controlled by the application owner, who runs computations in a manner suitable to them.

As such, these and other conventional mechanisms for trusted computing primarily benefit computing infrastructure owners and/or application owners, rather than data owners or end users. In general, it is not possible for users to demand or find a service with specific trusted computing and/or software settings. As a more concrete example, there are currently no solutions that enable a user to find a DNS resolver running specific software running inside a trusted computing environment.

Embodiments of the present disclosure address these and other problems, issues, and/or difficulties by providing techniques that facilitate matching users' trusted computing requirements with offered trusted computing services and/or user discovery of offered trusted computing services that are compatible with user requirements. These techniques involve two information sources: 1) service and cloud providers publish their respective services, the software run to provide those services, and the particularities of their trusted computing environments; and 2) users or applications publish or request one or more services, software providing those services, and trusted computing environment they need or find acceptable. Subsequently, the technique determines matches from the two information sources so that a user or an application can employ a desired service in the desired trusted environment, e.g., a server running a particular software version in a trusted computing enclave supporting either Intel or AMD trusted computing mechanisms and capable of providing an attestation whose root of trust is either Intel or AMD.

These embodiments can provide various benefits and/or advantages. For example, such techniques enable a user or an application to find or launch services with specific software and trusted computing settings, such as a trusted computing-capable cloud service that is willing to execute a given software (or any software). More specifically, such techniques facilitate finding a trusted computing-capable service instance that runs exactly the software that is desired, and the service instance can prove that it actually runs the software. For example, such techniques facilitate a user to request, and desirably find, a DNS resolver that cannot be used for commercial surveillance of the user's browsing history.

Furthermore, embodiments of the techniques disclosed herein have various technical features that distinguish them from conventional trusted computing mechanisms for cloud platforms. As one example, disclosed techniques address a need to match “offers” from multiple service providers to what the user wants, thereby providing the ability to choose between providers. In conventional mechanisms, an application owner or network manager simply commands the underlying cloud framework to provide what is needed. Even if there may be several sites and federated cloud farms connected together, the system still acts as a single entity.

As another example, in the disclosed techniques, the desired software and version may be indicated by a third party as being acceptable, as opposed to cloud frameworks where software is typically referred by a specific image file or a named instance in a registry.

As another example, the disclosed techniques involve a process between the user's software and a service provider. Convention mechanisms involve a process between application owner, network manager, and cloud framework. There may be a user of services started in the cloud framework, but only as a third party who is offered a service without any negotiation capabilities about the security of that service.

As another example, in conventional cloud platform mechanisms, there needs to be an agreement and access rights to create processes. In the disclosed techniques, there is no requirement for a relationship between the user and platform running the services. The only requirement is that the parties agree on what software can be run and on the relevant trusted computing parameters.

As another example, in the disclosed techniques, there is no need to start a new process if an existing process already runs the desired task. For instance, a new user can employ an existing DNS resolver service, so long as the service can vouch that it is secure by providing an attestation. In conventional cloud platform mechanisms, processes are created based on instructions of the application owner.

Various embodiments of the disclosed techniques will now be described in more detail, first from the end user's perspective and then from the service provider's perspective.

In various embodiments, each user or application makes a request for the service they need. The request includes information about the needed service, required or preferred software for the service, and any trusted computing parameters required for the user to trust a computing platform that provides the needed service. These trusted computing parameters are also referred to herein as “indicia of trust”. For example, the information about the needed service and software may include a human-readable service name and, optionally, a location (e.g., URL) from which the software can be downloaded and/or obtained.

Additionally, the required software can be identified in some cryptographically secure manner. This identification can be done in various ways according to various embodiments. For example, the required software can be identified by providing a hash value of the software image and all configuration data. If the user knows and has perhaps even personally verified that a given software performs the expected task and has no security vulnerabilities or hidden features, the user can indicate that he or she wants to use this specific software and version.

As another example, the required software can be indicated indirectly by pointing to a third party that can sign a statement that a given software image and configuration data is an acceptable software system for the desired function. For instance, commercial entities (e.g., Ericsson), OS vendors (e.g., Apple), non-governmental entities (e.g., Internet Society or the EFF), and governments might audit and review software to ensure that the software does what it is advertised to do and does not leak user information, for example.

Additionally, the required trusted computing parameters can be represented by roots of trust (e.g., from CPU manufacturers) and technology parameters such as type of trusted computing technology is in use, specific features that must be enabled or disabled for the user to trust secure operation of the service, etc. For example, the user may indicate trust in a specific AMD trusted computing technology but indicate lack of trust for a specific Intel trusted computing technology. Optionally, the user may omit from the request any such non-trusted technologies. As a more specific example, features such as hyperthreading may not be sufficiently reliable for use in security sensitive tasks due to discoveries of CPU vulnerabilities. The user's trusted computing parameters can indicate that hyperthreading should be disabled.

In a similar manner, service or cloud providers advertise or publish respective services that they are currently providing or able to provide, software used to provide the services, and any trusted computing parameters of the computing platform(s) that provide(s) the services.

FIG. 4 shows a high-level arrangement that illustrates embodiments in the context of two service providers (SP1 and SP2), a user or application needing a service (e.g., TCS), and a centralized (or remote) service database. Although the operations shown in FIG. 4 are given numerical labels, these are meant to facilitate explanation and do not imply any strict temporal order of the operations, unless specifically noted otherwise.

In operation 1, SP1 and SP2 publish to the service database a list of their respective offered services, software used to provide the services, and any trusted computing parameters of the computing platform(s) that provide(s) the services. For example, SP2 publishes this information for service A and SP2 publishes this information for services A and B. Since SP1's service A is offered with different software and/or trusted computing parameters than SP's service A, it is denoted A′ rather than A.

In operation 2, the user sends a search query or request to the service database, including the user-specific requirements discussed above. In this example, the user indicates the service and associated software/parameters represented by “A”. In operation 3, the service database returns the search result, indicating that “A” is offered by SP2. Note that the service database omits A′ offered by SP1 from the results because its software and/or trusted computing parameters do not match the user's requirements.

In operation 4, the user contacts SP2 to establish a connection to an instance of A having the required software and/or trusted computing parameters. For example, the user can contact an address of SP2 that is associated with service requests. In operation 5, SP2 establishes a connection of the user to service A. This can involve various sub-operations (not shown). For example, SP2 can determine if a suitable instance of A is already running and, if so, whether its load level permits adding the user. If there is no suitable service or the load level does not permit addition, SP2 can initiate another instance of service A for the benefit of the user. In either case, SP2 can then redirect the user's connection from the initial address to an address associated with service A's instance for the user.

Subsequently, the user and service A instance establish a session, e.g., by creating a TCP, QUIC, or TLS channel between them. Using this channel, the service A instance can provide an attestation of the particular software and trusted computing parameters used to provide the service. The user can then verify the attestation. In some cases, the service A instance can also provide additional information, such as third party signatures concerning a software version being acceptable. The user can also verify such third-party information, if provided.

Although the sub-operations of operation 5 are described in the preceding paragraph as being separate, they can be bound together for security reasons. For example, it can be preferable and/or necessary that the attestation is actually from the service A instance with which the connection established; otherwise, one could send an attestation from a valid instance in a connection to an invalid instance. Similarly, the attestation provides a cryptographic indication (e.g., hash) of what software image is being run; any information of the software needs to be bound to the same indication.

One secure approach is performing all of these sub-operations as part of the same exchange. For example, a Diffie-Hellman handshake to establish a secure connection can also exchange attestation information within the same connection and bound to the same keys, and any software information is passed along in the same messages as the attestation information. Another approach is ensuring that even if the sub-operations are executed in sequence, each sub-operation uses key(s) established in previous sub-operation(s).

In operation 6, after establishing the connection, the user and service A instance at SP2 perform tasks associated with service A, exchange inputs/commands/results/outputs, etc. in service-appropriate manner.

Many other variants of the above-described embodiments are also possible. In some embodiments, a cloud or service provider can also publish or advertise that it is willing to run any software that the user or application requires. Such general service is typically limited to subscribers of cloud service. For example, the service can be designated as a wildcard (e.g., “*”) and specific software versions are not needed. In such embodiments, the user or application must provide the software to be executed, e.g., during operation 5 described above. Even so, the could or service provider can advertise the trusted computing parameters that will be used with any software provided by the user.

For service instances already running, the cloud or service provider may publish their service names and software versions, if multi-user service instances are allowed, etc.

In some embodiments, the service provider may be willing to run any software as required, but only if it has been indirectly verified by a third party. In this case the service may be designated by a wildcard with an additional condition expressed in the service parameters.

In some embodiments, the user or application may specify that the services are either single-use or multi-use. A single-use service is a service instance dedicated for the user or application, while a multi-use service can serve multiple users. For instance, a DNS resolver server may serve multiple users with a single instance, which may improve security since it becomes more difficult to associate DNS query traffic with any particular user.

The centralized database of the exemplary arrangement shown in FIG. 4 can be beneficial but can have certain drawbacks. For example, someone needs to operate and control the database, service providers need a relationship with the database to be able to publish something to it, etc. In some scenarios, a distributed database may be preferable. An exemplary way to implement a distributed database is to use known services to query additional information about other available services or services with different software or trusted computing settings.

In such embodiments, a user or application is configured in some way with initial services that can be used in this manner. This configuration can be manual or based on auto-discovery of underlying network connectivity. Using those configured services, the user or application can retrieve the complete set of available services and choose the desired service to be used.

An exemplary procedure according to these embodiments is described as follows. Although the operations are given numerical labels, these are meant to facilitate explanation and do not imply any strict temporal order of the operations, unless specifically noted otherwise.

In operation 1, the user or application discovers and/or is configured with an initial set of database services. In operations 2-3, the user or application queries the initial set of database services for a full set of database services and subsequently receives the requested information. In operation 4, the user or application queries the full set of database services for the actual desired services, including any relevant software and/or trusted computing parameter information associated with the desired services. Note that if the desired service is a database service, then operation 4 can be omitted since the relevant information was received in operation 3.

In operation 5, the user or application receives the query result, indicating any availability of requested services (including any wildcards, as discussed above). In operations 6-7, the user or application determines which of the available services to use for the actual task, and proceeds to establish a connection with and use that service, in the same manner as discussed above in relation to FIG. 4.

One way to implement a distributed database without any extra software or coordination is to use DNS of the individual service providers. For example, user devices (e.g., computers) are typically configured with knowledge of DNS resolvers and domain names. As such, all known DNS resolvers can be treated as the initial set of database services discussed above. Users can query the DNS resolvers for specific services, software, and trusted computing parameter settings that are available and known by each DNS resolver. Once this information is available, the user or application can switch to the desired service.

An exemplary procedure illustrating these embodiments is described as follows. Although the operations are given numerical labels, these are meant to facilitate explanation and do not imply any strict temporal order of the operations, unless specifically noted otherwise.

In operation 1, the user or application discovers available basic services, such as a local ISP DNS resolver (e.g., discovery via DHCP) or a Google DNS resolver (e.g., 8.8.8.8 by device configuration). In operation 2, the user or application makes a DNS query via these basis services for the full list of services and parameters offered by the same service provider. RFC 6763 published by IETF describes an example implementation where DNS is used to find services such as printers, web pages, etc. Another example is described in “Adaptive DNS Resolver Discovery”, an Internet draft also published by IETF. These or other similar techniques could be used to discover any specific service.

In operation 3, the user or application receives the results of these queries, i.e., a full list of DNS resolvers. In operation 4, the user or application can query the full list of DNS resolvers for information about the desired services (unless the DNS service was what was desired). In operations 5-6, the user or application receives query results and determines from them which services and service providers offer services that the user or application finds acceptable. For instance, the user's device may decide that another Google DNS resolver at a different address can provide the trusted DNS that is required, or that an ISP's NTP service matches the requirements for a time server. In operation 7, the user or application establishes a connection with and uses that service, in a similar manner as discussed above in relation to FIG. 4.

Although embodiments are described above in terms of implementations, skilled persons will readily comprehend that disclosed techniques can be embodied in standards or specifications, including any of the following:
Extensions for cloud frameworks to allow for searching for services that the cloud frameworks are willing to execute or are already executing.
Extensions to DNS for being able to provide information about services that are available, or about trusted computing parameters associated with them.
Extensions to DNS discovery processes to able to find a desirable, trusted-computing enhanced DNS resolvers.

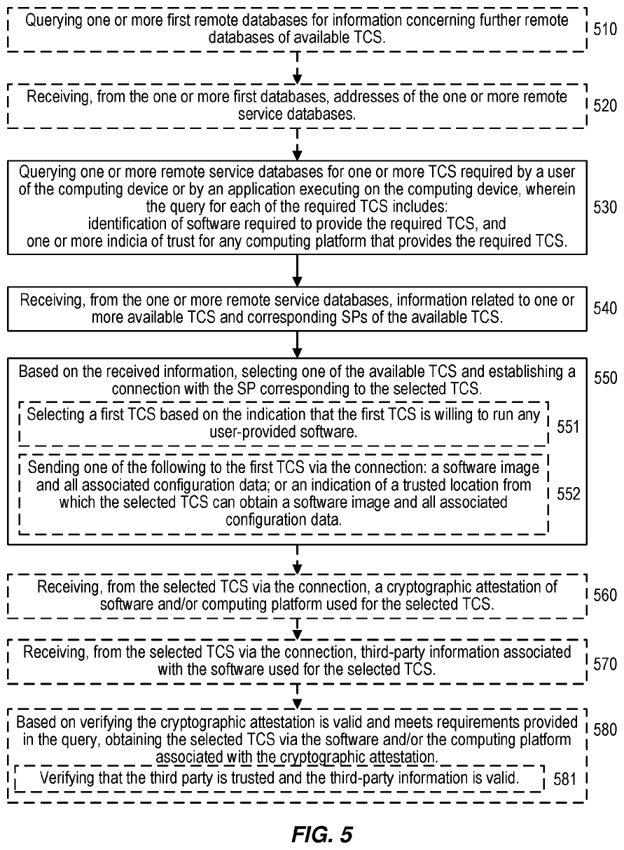

The embodiments described above can be further illustrated with reference to FIGS. 5-7, which depict exemplary methods (e.g., procedures) for a computing device, a service provider of trusted computing services (TCS), and a service database of TCS, respectively. Put differently, various features of the operations described below correspond to various embodiments described above. The exemplary methods shown in FIGS. 5-7 can be used cooperatively to provide benefits, advantages, and/or solutions to problems described herein. Although the exemplary methods are illustrated in FIGS. 5-7 by specific blocks in particular orders, the operations corresponding to the blocks can be performed in different orders than shown and can be combined and/or divided into operations having different functionality than shown. Optional blocks and/or operations are indicated by dashed lines.

More specifically, FIG. 5 illustrates an exemplary method (e.g., procedure) for a computing device to obtain TCS from service providers (SPs), according to various embodiments of the present disclosure. For example, the exemplary method shown in FIG. 5 can be performed by a computing device (e.g., desktop, laptop, smartphone, tablet, wireless device, user equipment, IoT device, etc. or component thereof) such as described elsewhere herein.

The exemplary method can include the operations of block 530, where the computing device can query one or more remote service databases for one or more TCS required by a user of the computing device or by an application executing on the computing device. The query for each of the required TCS can include identification of software required to provide the required TCS, and one or more indicia of trust for any computing platform that provides the required TCS. The exemplary method can also include the operations of block 540, where the computing device can receive, from the one or more remote service databases, information related to one or more available TCS and corresponding SPs of the available TCS. The exemplary method can also include the operations of block 550, where the computing device can, based on the received information, select one of the available TCS and establishing a connection with the SP corresponding to the selected TCS.

In some embodiments, the identification of software in the query for each required TCS can include one of the following: a hash value of a software image and of all associated configuration data; or an indication of a third party that can sign a statement that a particular software image and configuration data is acceptable for the required TCS.

In some embodiments, the query for each required TCS can include a human-readable service name associated with the required TCS, and the identification of software in the query for each required TCS can include a location from which the software can be obtained.

In some embodiments, the indicia of trust in the query for each required TCS include one or more of the following:
roots of trust from a manufacturer of CPUs trusted to perform the required TCS;
one or more types of computing technology trusted to perform the required TCS;
one or more types of computing technology not trusted to perform the required TCS; and
features that must be enabled or disabled for trusting a computing platform to perform the required TCS.
   In some of these embodiments, the one or more types of computing technology trusted to perform the required TCS can include any of the following: Intel Software Guard eXtensions (SGX), AMD Secure Encrypted Virtualization (SEV), and ARM TrustZone.

In some embodiments, the query for each required TCS can include a requirement for the required TCS to be single-user, a requirement for the required TCS to be multi-user, or an indication that the required TCS can be single-user or multi-user.

In some embodiments, the exemplary method can also include the operations of blocks 510-520. In block 510, the computing device can query one or more first remote databases for information concerning further remote databases of available TCS. In some embodiments, the computing device can be preconfigured with addresses of the one or more first remote databases. In block 520, the computing device can receive, from the one or more first databases, addresses of the one or more remote service databases. These received addresses can be used, for example, for the query of block 530. In some of these embodiments,

In some of these embodiments, the one or more first remote databases (e.g., queried in block 510) can be associated with respective domain names and domain name service (DNS) resolvers. In some of these embodiments, the one or more remote service databases (e.g., queried in block 530) can also be associated with respective domain names and DNS resolvers.

In some embodiments, the exemplary method can also include the operations of blocks 560 and 580. In block 560, the computing device can receive, from the selected TCS via the connection (e.g., established in block 550), a cryptographic attestation associated with software and/or computing platform used for the selected TCS. In block 580, the computing device can, based on verifying the cryptographic attestation is valid and meets requirements provided in the query, obtain the selected TCS via the software and/or the computing platform associated with the cryptographic attestation.

In some of these embodiments, the exemplary method can also include the operations of block 570, where the computing device can receive, from the selected TCS, third-party information associated with the software used for the selected TCS. For example, the third-party information can be a digital signature indicating that a particular version of the software is acceptable for the selected TCS. In these embodiments, the obtaining operations of block 580 can also be based on the operations of sub-block 581, where the computing device verifies that the third party is trusted and the third-party information is valid.

In other of these embodiments, the received information (e.g., in block 540) related to a first TCS of the available TCS includes an indication that the first TCS is willing to run any user-provided software, and trusted computing parameters associated with a computing platform used to run any user-provided software. In such embodiments, the selecting and establishing operations of block 550 can include the operations of sub-blocks 551-552, where the computing device can select the first TCS based on the indication that the first TCS is willing to run any user-provided software, and send one of the following to the first TCS via the connection: a software image and all associated configuration data; or an indication of a trusted location from which the selected TCS can obtain a software image and all associated configuration data.

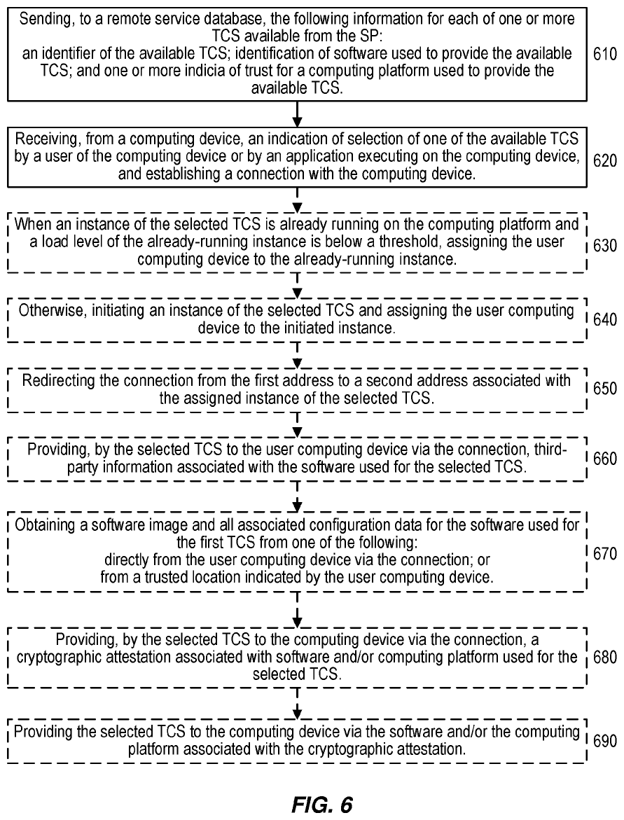

In addition, FIG. 6 illustrates an exemplary method (e.g., procedure) for a SP of TCS, according to various embodiments of the present disclosure. For example, the exemplary method shown in FIG. 6 can be performed by a computing platform (e.g., processors executing software stored in memories) associated with the SP, such as computing platforms described elsewhere herein. As such, references below to operations by a SP can also be understood as operations performed by the SP's computing platform.

The exemplary method can include the operations of block 610, where the SP can send, to a remote service database, the following information related to each of one or more TCS available from the SP: an identifier of the available TCS; identification of software used to provide the available TCS; and one or more indicia of trust for a computing platform used to provide the available TCS. The exemplary method can also include the operations of block 620, where the SP can receive, from a computing device, an indication of selection of one of the available TCS by a user of the computing device or by an application executing on the computing device, and where the SP can establish a connection with the computing device.

In some embodiments, the identification of software for each available TCS can include one of the following: a hash value of a software image and of all associated configuration data; or an indication of a third party that can sign a statement that a particular software image and configuration data is acceptable for the available TCS.

In other embodiments, for each available TCS, the identifier of the available TCS includes a human-readable service name and the identification of the software can include a location from which the software can be obtained.

In some embodiments, the indicia of trust for each available TCS can include one or more of the following:
roots of trust from a manufacturer of CPUs used to provide the available TCS;
one or more types of computing technology used to provide the available TCS; and
features that are enabled or disabled in the computing platform used to provide the available TCS.
   In some of these embodiments, the one or more types of computing technology used to provide the available TCS includes any of the following: Intel SGX, AMD SEV, and ARM TrustZone.

In some embodiments, the information sent to the remote service database also includes one of the following for each available TCS: an indication that the available TCS can only be single-user, an indication that the available TCS can only be multi-user, or an indication that the available TCS can be single-user or multi-user.

In some embodiments, receiving the indication of a selection (e.g., in block 620) is via a first address. In such embodiments, the exemplary method can also include the operations of blocks 630-650. In block 630, the SP can, when an instance of the selected TCS is already running on the computing platform and a load level of the already-running instance is below a threshold, assign the user computing device to the already-running instance. In block 640, the SP can otherwise (i.e., when the conditions in block 630 are not met) initiate an instance of the selected TCS and assign the user computing device to the initiated instance. In block 650, the SP can redirect the connection from the first address to a second address associated with the assigned instance of the selected TCS (i.e., assigned in block 630 or 640, as the case may be).

In some embodiments, the remote service database can be associated with a domain name and a DNS resolver.

In some embodiments, the exemplary method can also include the operations of blocks 680-690. In block 680, the SP can provide, by the selected TCS to the computing device via the connection, a cryptographic attestation associated with software and/or computing platform used for the selected TCS. In block 690, the SP can provide the selected TCS to the computing device via the software and/or the computing platform associated with the cryptographic attestation.

In some of these embodiments, the exemplary method can also include the operations of block 660, where the SP can provide, by the selected TCS to the user computing device via the connection, third-party information associated with the software used for the selected TCS. In some embodiments, the third-party information can be a digital signature indicating that a particular version of the software is acceptable for the selected TCS.

In other of these embodiments, the information related to a first TCS (of the available TCS) that is sent to the remote service database (e.g., in block 610) can include an indication that the first TCS is willing to run any user-provided software, as well as trusted computing parameters associated with a computing platform used to run any user-provided software. In such embodiments, the selected TCS (e.g., as indicated in block 620) can be the first TCS and the exemplary method can also include the operations of block 670, where the SP can obtain a software image and all associated configuration data for the software used for the first TCS either directly from the user computing device via the connection, or from a trusted location indicated by the user computing device. In such embodiments, the cryptographic attestation (e.g., provided in block 680) can be based on the obtained software image and all associated configuration data.

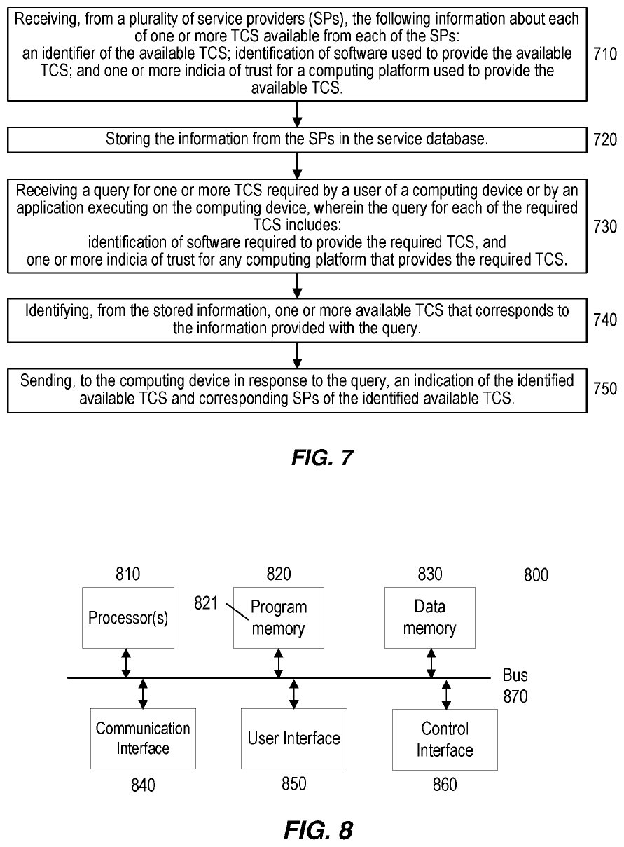

In addition, FIG. 7 illustrates an exemplary method (e.g., procedure) for a service database to match required TCS to available TCS, according to various embodiments of the present disclosure. For example, the exemplary method shown in FIG. 7 can be performed by a service database (e.g., storage medium and associated processing and communications circuitry/software), such as described elsewhere herein.

The exemplary method can include the operations of block 710, where the service database can receive, from a plurality of SPs, the following information related to each of one or more TCS available from each of the SPs: an identifier of the available TCS; identification of software used to provide the available TCS; and one or more indicia of trust for a computing platform used to provide the available TCS. The exemplary method can also include the operations of block 720, where the service database can store the information from the SPs (i.e., in a non-transitory storage medium).

The exemplary method can also include the operations of block 730, where the service database can receive a query for one or more TCS required by a user of a computing device or by an application executing on the computing device. The query for each of the required TCS can include identification of software required to provide the required TCS, and one or more indicia of trust for any computing platform that provides the required TCS.

The exemplary method can also include the operations of block 740, where the service database can identify, from the stored information, one or more available TCS that corresponds to the information provided with the query. For example, the service database can determine that:
one or more available TCS match a required TCS identified by the query;
software used to provide the available TCS matches the identification of software in the query, and/or that user-provided software is allowed for the available TCS; and/or
indicia of trust for the available TCS match the indicia of trust in the query.

The exemplary method can also include the operations of block 750, where the service database can send to the computing device in response to the query, an indication of the identified available TCS and corresponding SPs of the identified available TCS.

In some embodiments, the identification of software in the query for each required TCS can include one of the following: a hash value of a software image and of all associated configuration data; or an indication of a third party that can sign a statement that a particular software image and configuration data is acceptable for the required TCS.

In some embodiments, the query for each required TCS can include a human-readable service name associated with the required TCS, and the identification of software in the query for each required TCS can include a location from which the software can be obtained.

In some embodiments, the indicia of trust in the query for each required TCS include one or more of the following:
a roots of trust from a manufacturer of CPUs trusted to perform the required TCS;
one or more types of computing technology trusted to perform the required TCS;
one or more types of computing technology not trusted to perform the required TCS; and
features that must be enabled or disabled for trusting a computing platform to perform the required TCS.
   In some of these embodiments, the one or more types of computing technology trusted to perform the TCS includes any of the following: Intel SGX, AMD SEV, and ARM TrustZone.

In some embodiments, the query for each required TCS can include a requirement for the required TCS to be single-user, a requirement for the required TCS to be multi-user, or an indication that the required TCS can be single-user or multi-user.

In some embodiments, the service database can be associated with a domain name and a DNS resolver.

In some embodiments, the identification of software for each available TCS can include one of the following: a hash value of a software image and of all associated configuration data; or an indication of a third party that can sign a statement that a particular software image and configuration data is acceptable for the available TCS.

In other embodiments, for each available TCS, the identifier of the available TCS can include a human-readable service name and the identification of the software can include a location from which the software can be obtained.

In some embodiments, the indicia of trust for each available TCS can include one or more of the following:
roots of trust from a manufacturer of CPUs used to provide the available TCS;
one or more types of computing technology used to provide the available TCS; and
features that are enabled or disabled in the computing platform used to provide the available TCS.
   In some of these embodiments, the one or more types of computing technology used to provide the available TCS includes any of the following: Intel SGX, AMD SEV, and ARM TrustZone.

In some embodiments, the received information related to each available TCS includes one of the following: an indication that the available TCS can only be single-user, an indication that the available TCS can only be multi-user, or an indication that the available TCS can be single-user or multi-user.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

FIG. 8 shows a block diagram of an exemplary computing device or user equipment (UE) 800 (hereinafter referred to as “UE 800”) according to various embodiments of the present disclosure, including those described above with reference to other figures. For example, UE 800 can be configured by execution of instructions, stored on a computer-readable medium, to perform operations corresponding to one or more of the exemplary methods described herein.

UE 800 can include a processor 810 (also referred to as “processing circuitry”) that can be operably connected to a program memory 820 and/or a data memory 830 via a bus 870 that can comprise parallel address and data buses, serial ports, or other methods and/or structures known to those of ordinary skill in the art. Program memory 820 can store software code, programs, and/or instructions (collectively shown as computer program product 821 in FIG. 8) that, when executed by processor 810, can configure and/or facilitate UE 800 to perform various operations, including operations corresponding to various exemplary methods described herein. As part of or in addition to such operations, execution of such instructions can configure and/or facilitate UE 800 to communicate using one or more wired or wireless communication protocols, including one or more wireless communication protocols standardized by 3GPP, 3GPP2, or IEEE, such as those commonly known as 5G/NR, LTE, LTE-A, UMTS, HSPA, GSM, GPRS, EDGE, 1×RTT, CDMA2000, 802.11 WiFi, HDMI, USB, Firewire, etc., or any other current or future protocols that can be utilized in conjunction with communication interface 840, user interface 850, and/or control interface 860.

As another example, processor 810 can execute program code stored in program memory 820 that corresponds to MAC, RLC, PDCP, and RRC layer protocols standardized by 3GPP (e.g., for NR and/or LTE). As a further example, processor 810 can execute program code stored in program memory 820 that, together with communication interface 840, implements corresponding PHY layer protocols, such as Orthogonal Frequency Division Multiplexing (OFDM), Orthogonal Frequency Division Multiple Access (OFDMA), and Single-Carrier Frequency Division Multiple Access (SC-FDMA). As another example, processor 810 can execute program code stored in program memory 820 that, together with communication interface 840, implements device-to-device (D2D) communications with other compatible devices and/or UEs.

Program memory 820 can also include software code executed by processor 810 to control the functions of UE 800, including configuring and controlling various components such as communication interface 840, user interface 850, and/or control interface 860. Program memory 820 can also comprise one or more application programs and/or modules comprising computer-executable instructions embodying any of the exemplary methods described herein. Such software code can be specified or written using any known or future developed programming language, such as e.g., Java, C++, C, Objective C, HTML, XHTML, machine code, and Assembler, as long as the desired functionality, e.g., as defined by the implemented method steps, is preserved. In addition, or as an alternative, program memory 820 can comprise an external storage arrangement (not shown) remote from UE 800, from which the instructions can be downloaded into program memory 820 located within or removably coupled to UE 800, so as to enable execution of such instructions.

Data memory 830 can include memory area for processor 810 to store variables used in protocols, configuration, control, and other functions of UE 800, including operations corresponding to, or comprising, any of the exemplary methods described herein. Moreover, program memory 820 and/or data memory 830 can include non-volatile memory (e.g., flash memory), volatile memory (e.g., static or dynamic RAM), or a combination thereof. Furthermore, data memory 830 can comprise a memory slot by which removable memory cards in one or more formats (e.g., SD Card, Memory Stick, Compact Flash, etc.) can be inserted and removed.

Persons of ordinary skill will recognize that processor 810 can include multiple individual processors (including, e.g., multi-core processors), each of which implements a portion of the functionality described above. In such cases, multiple individual processors can be commonly connected to program memory 820 and data memory 830 or individually connected to multiple individual program memories and or data memories. More generally, persons of ordinary skill in the art will recognize that various protocols and other functions of UE 800 can be implemented in many different computer arrangements comprising different combinations of hardware and software including, but not limited to, application processors, signal processors, general-purpose processors, multi-core processors, ASICs, fixed and/or programmable digital circuitry, analog baseband circuitry, radio-frequency circuitry, software, firmware, and middleware.

Communication interface 840 can include radio-frequency transmitter and/or receiver functionality that facilitates the UE 800 to communicate with other equipment supporting like wireless communication standards and/or protocols. In some embodiments, the communication interface 840 includes one or more transmitters and one or more receivers that enable UE 800 to communicate according to various protocols and/or methods proposed for standardization by 3GPP and/or other standards bodies. For example, such functionality can operate cooperatively with processor 810 to implement a PHY layer based on OFDM, OFDMA, and/or SC-FDMA technologies, such as described herein with respect to other figures.

In some embodiments, communication interface 840 includes one or more transmitters and one or more receivers that can facilitate the UE 800 to communicate with various LTE, LTE-Advanced (LTE-A), and/or NR networks according to standards promulgated by 3GPP. In some embodiments of the present disclosure, the communication interface 840 includes circuitry, firmware, etc. necessary for the UE 800 to communicate with various NR, NR-U, LTE, LTE-A, LTE-LAA, UMTS, and/or GSM/EDGE networks, also according to 3GPP standards. In some embodiments, communication interface 840 can include circuitry supporting D2D communications between UE 800 and other compatible devices.

In some embodiments, communication interface 840 includes circuitry, firmware, etc. necessary for the UE 800 to communicate with various CDMA2000 networks, according to 3GPP2 standards. In some embodiments, the communication interface 840 can be capable of communicating using radio technologies that operate in unlicensed frequency bands, such as IEEE 802.11 WiFi that operates using frequencies in the regions of 2.4, 5.6, and/or 60 GHz. In some embodiments, communication interface 840 can include a transceiver that is capable of wired communication, such as by using IEEE 802.3 Ethernet technology. The functionality particular to each of these embodiments can be coupled with and/or controlled by other circuitry in the UE 800, such as the processor 810 executing program code stored in program memory 820 in conjunction with, and/or supported by, data memory 830.

User interface 850 can take various forms depending on the particular embodiment of UE 800, or can be absent from UE 800 entirely. In some embodiments, user interface 850 can comprise a microphone, a loudspeaker, slidable buttons, depressible buttons, a display, a touchscreen display, a mechanical or virtual keypad, a mechanical or virtual keyboard, and/or any other user-interface features commonly found on mobile phones. In other embodiments, the UE 800 can comprise a tablet computing device including a larger touchscreen display. In such embodiments, one or more of the mechanical features of the user interface 850 can be replaced by comparable or functionally equivalent virtual user interface features (e.g., virtual keypad, virtual buttons, etc.) implemented using the touchscreen display, as familiar to persons of ordinary skill in the art. In other embodiments, the UE 800 can be a digital computing device, such as a laptop computer, desktop computer, workstation, etc. that comprises a mechanical keyboard that can be integrated, detached, or detachable depending on the particular embodiment. Such a digital computing device can also comprise a touch screen display. Some embodiments of the UE 800 having a touch screen display are capable of receiving user inputs, such as inputs related to exemplary methods described herein or otherwise known to persons of ordinary skill.

In some embodiments, UE 800 can include an orientation sensor, which can be used in various ways by features and functions of UE 800. For example, UE 800 can use outputs of the orientation sensor to determine when a user has changed the physical orientation of the UE 800's touch screen display. An indication signal from the orientation sensor can be available to any application program executing on the UE 800, such that an application program can change the orientation of a screen display (e.g., from portrait to landscape) automatically when the indication signal indicates an approximate 80-degree change in physical orientation of the device. In this exemplary manner, the application program can maintain the screen display in a manner that is readable by the user, regardless of the physical orientation of the device. In addition, the output of the orientation sensor can be used in conjunction with various embodiments of the present disclosure.

A control interface 860 of the UE 800 can take various forms depending on the particular embodiment of UE 800 and of the particular interface requirements of other devices that the UE 800 is intended to communicate with and/or control. For example, the control interface 860 can comprise an RS-232 interface, a USB interface, an HDMI interface, a Bluetooth interface, an IEEE (“Firewire”) interface, an I²C interface, a PCMCIA interface, or the like. In some embodiments of the present disclosure, control interface 860 can comprise an IEEE 802.3 Ethernet interface such as described above. In some embodiments of the present disclosure, the control interface 860 can comprise analog interface circuitry including, for example, one or more digital-to-analog converters (DACs) and/or analog-to-digital converters (ADCs).

Persons of ordinary skill in the art can recognize the above list of features, interfaces, and radio-frequency communication standards is merely exemplary, and not limiting to the scope of the present disclosure. In other words, the UE 800 can comprise more functionality than is shown in FIG. 8 including, for example, a video and/or still-image camera, microphone, media player and/or recorder, etc. Moreover, communication interface 840 can include circuitry necessary to communicate using additional radio-frequency communication standards including Bluetooth, GPS, and/or others. Moreover, the processor 810 can execute software code stored in the program memory 820 to control such additional functionality. For example, directional velocity and/or position estimates output from a GPS receiver can be available to any application program executing on the UE 800, including any program code corresponding to and/or embodying any exemplary methods (e.g., procedures) described herein.

Furthermore, persons or ordinary skill will recognize that UE 800 is only one example of a computing device and that other exemplary computing devices can be configured differently than UE 800, such as by different processing circuitry, memory and/or storage media, and/or communication circuitry.

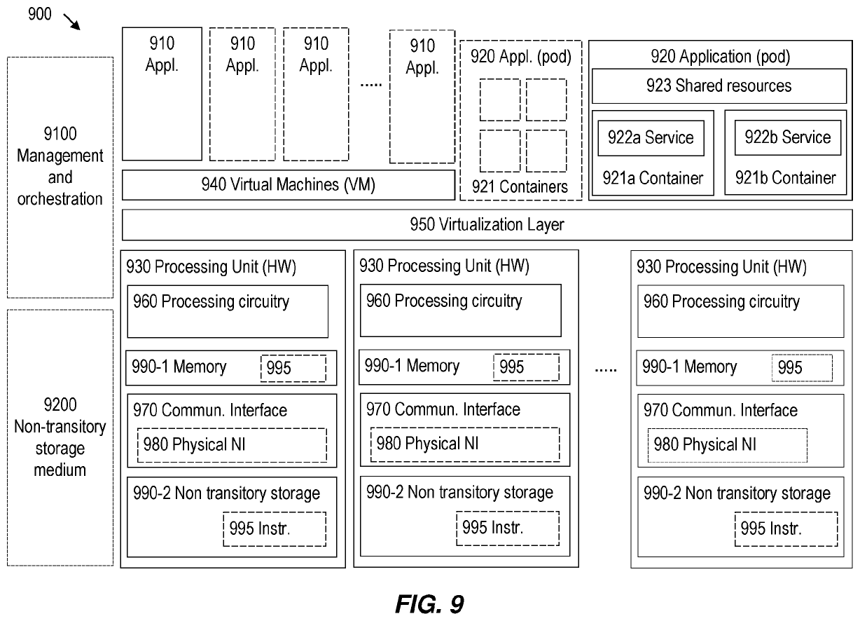

FIG. 9 is a block diagram of an exemplary computing platform that can be used by service providers (SPs) of TCS and/or by a service database for TCS, according to various embodiments described above. For example, each of the SPs and the service database can use different instances of the computing platform shown in FIG. 9, and such instances can be physically separated from each other, e.g., in a cloud computing environment.

In the exemplary arrangement shown in FIG. 9, functions are implemented as virtual components executed by one or more virtual machines in virtual environment 900 hosted by a plurality of processing units 930. Such processing units can be computing machines arranged in a cluster (e.g., such as in a data center or customer premise equipment (CPE)) where many hardware nodes work together and are managed via management and orchestration (MANO) function 9100, which, among other tasks, oversees lifecycle management of various applications 910 and/or 920. In some embodiments, however, such virtual components can be executed by one or more physical computing machines, e.g., without (or with less) virtualization of the underlying resources of processing units 930.

In some embodiments, processing units 930 can be commercial off-the-shelf (COTS) units, such as graphics processing units (GPUs), rack-mounted x86 server boards (e.g., based on Intel or AMD processors), reduced instruction-set computer (RISC, e.g., ARM) boards, etc. Each processing unit 930 can include processing circuitry 960 and memory 990. Memory 990 can include non-persistent memory 990-1 (e.g., for permanent or semi-permanent storage) and persistent memory 990-2 (e.g., for temporary storage), each of which can store instructions 995 (also referred to as software or computer program product).

Processing circuitry 960 can include general-purpose or special-purpose hardware devices, such as one or more Intel x86-family processors (or equivalent), reduced instruction-set computing (RISC) processors (e.g., ARM), stream or vector multiprocessors, application-specific integrated circuits (ASICs), or any other type of processing circuitry including digital or analog hardware components. Each processing unit 930 can include one or more high-speed communication interfaces 970, each of which can include a physical network interface 980. The respective communication interfaces 970 can be used for communication among the processing units 930, and/or with other computing hardware internal and/or external to system 900.

Memory 990 can store instructions 995 executable by processing circuitry 960 whereby various applications 910 and/or 920 can be operative for various features, functions, procedures, etc. of the embodiments disclosed herein. For example, instructions 995 can include program instructions that, when executed by processing circuitry 960, can configure processing unit 930 to perform operations corresponding to the methods or procedures described herein, including those related to embodiments of the TRS.

Memory 990 can also store instructions 995 executable by processing circuitry 960 to instantiate one or more virtualization layers 950 (also referred to as hypervisor or virtual machine monitor, VMM). In some embodiments, virtualization layer 950 can be used to provide a plurality of virtual machines (VMs) 940 that are abstracted from the underlying processing units 930. For example, virtualization layer 950 can present a virtual operating platform that appears like computing hardware to containers and/or pods hosted by environment 900. Moreover, each VM (e.g., as facilitated by virtualization layer 950) can manifest itself as a software implementation of a physical machine that runs programs as if they were executing on a physical, non-virtualized machine. Each VM can have dedicated processing units 930 or can share resources of one or more processing units 930 with other VMs.

Memory 990 can store software to execute each VM 940 as well as software allowing a VM 940 to execute functions, features and/or benefits described in relation with some embodiments described herein. VMs 940 can include virtual processing, virtual memory, virtual networking or interface and virtual storage, and can be run by virtualization layer 950. As shown in FIG. 9, various applications 910 can run on VMs 940.

As a specific example, applications 910 can be implemented in WebAssembly, a binary instruction format designed as a portable compilation target for programming languages. In other words, virtualization layer 950 can provide VMs 940 that are capable of running applications, that are compiled into WebAssembly executables. As another specific example, virtualization layer 950 can provide Java VMs 940 that are capable of running applications written in the Java programming language or written in other programming languages and compiled into Java byte code.

In other embodiments, virtualization layer 950 can host various applications 920 arranged in pods. Each pod can include one or more containers 921, such as 921a-b shown for a particular application 920 in FIG. 9. Container 921a-b can encapsulate respective services 922a-b of a particular application 920. For example, a “pod” (e.g., a Kubernetes pod) can be a basic execution unit of an application, i.e., the smallest and simplest unit that can be created and deployed in environment 900. Each pod can include a plurality of resources shared by containers within the pod (e.g., resources 923 shared by containers 921a-b). For example, a pod can represent processes running on the processing units (or VMs) and can encapsulates an application's containers (including services therein), storage resources, a unique network IP address, and options that govern how the container(s) should run. In general, containers can be relatively decoupled from underlying physical or virtual computing infrastructure.

In some embodiments, some or all of processing units 930 can include, or be implemented as, trusted computing hardware such as illustrated in FIG. 2. For example, these trusted processing units can have hardware features such as Intel SGX, AMD SEV, and/or ARM TrustZone. Likewise, some or all of containers 921 can be implemented as secure containers such as illustrated in FIG. 2. In this manner, services 922 running in the secure containers 921 on trusted processing units 930 can be trusted computing services (TCS), as described elsewhere herein. Similarly, some or all of VMs 940 can be trusted VMs that are usable to provide TCS for applications 910.

In some embodiments, computing platform 900 can include a non-transitory storage medium 9200 that can be used to store and retrieve information related to available TCS, as performed by service database embodiments described elsewhere herein. In such embodiments, applications 910 and/or 920 can include database applications that perform service database operations using one or more processing units 930, which in some instances can be trusted processing units as described in the preceding paragraph.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Furthermore, functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification, drawings and embodiments thereof, can be used synonymously in certain instances, including, but not limited to, e.g., data and information. It should be understood that, while these words and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

Example embodiments of the techniques and apparatus described herein include, but are not limited to, the following enumerated embodiments:

A1. A method performed by a computing device to obtain trusted computing services (TCS) from service providers (SP), the method comprising:
querying one or more remote service databases for one or more TCS required by a user of the computing device or by an application executing on the computing device, wherein the query for each of the required TCS includes the following: identification of software required to provide the required TCS, and one or more indicia of trust for any computing platform that provides the TCS;
receiving, from the one or more remote service databases, information related to one or more available TCS and corresponding SPs of the available TCS; and
based on the received information, selecting one of the available TCS and establishing a connection with the SP corresponding to the selected TCS.

A2. The method of embodiment A1, wherein the identification of software in the query for each required TCS includes one of the following:
a hash value of a software image and of all associated configuration data; or
an indication of a third party that can sign a statement that a particular software image and configuration data is acceptable for the required TCS.

A3. The method of any of embodiments A1-A2, wherein:
the query for each required TCS includes a human-readable service name associated with the required TCS; and
the identification of software in the query for each required TCS includes a location from which the software can be obtained.

A4. The method of any of embodiments A1-A3, wherein the indicia of trust in the query for each TCS include one or more of the following:
roots of trust from a manufacturer of CPUs trusted to perform the TCS;
one or more types of computing technology trusted to perform the TCS;
one or more types of computing technology not trusted to perform the TCS; and
features that must be enabled or disabled for trusting a computing platform to perform the TCS.

A5. The method of embodiment A4, wherein the one or more types of computing technology trusted to perform the TCS includes any of the following:
Intel Software Guard eXtensions (SGX);
AMD Secure Encrypted Virtualization (SEV), and
ARM TrustZone.

A6. The method of any of embodiments A1-A5, wherein the query for each required TCS includes one of the following:
a requirement for the required TCS to be single-user;
a requirement for the required TCS to be multi-user; or an indication that the required TCS can be single-user or multi-user.

A7. The method of any of embodiments A1-A6, further comprising:
querying one or more first remote databases for information concerning further remote databases of available TCS; and
receiving, from the one or more first databases, addresses of the one or more remote service databases.

A8. The method of embodiment A7, wherein the one or more first remote databases are associated with respective domain names and domain name service (DNS) resolvers.

A9. The method of embodiment A8, wherein the one or more remote service databases are associated with respective domain names and DNS resolvers.

A10. The method of any of embodiments A7-A9, wherein the computing device is preconfigured with addresses of the one or more first remote databases.

A11. The method of any of embodiments A1-A10, further comprising:
receiving, from the selected TCS via the connection, a cryptographic attestation of at least one of the following used for the selected TCS: software and computing platform; and
based on verifying the cryptographic attestation is valid and meets requirements provided in the query, obtaining the selected TCS via the software and the computing platform associated with the attestation.

A12. The method of embodiment A11, further comprising receiving, from the selected TCS, third-party information associated with the software used for the selected TCS; wherein obtaining the selected TCS is also based on verifying that the third party is trusted and the third-party information is valid.

A13. The method of embodiment A12, wherein the third-party information is a digital signature indicating that a particular version of the software is acceptable for the selected TCS.

A14. The method of embodiment A11, wherein the received information related to a first TCS of the available TCS includes the following:
an indication that the first TCS is willing to run any user-provided software; and
trusted computing parameters associated with a computing platform used to run any user-provided software.

A15. The method of embodiment A14, wherein selecting one of the available TCS and establishing a connection with the SP corresponding to the selected TCS comprises:
selecting the first TCS based on the indication that the first TCS is willing to run any user-provided software; and
sending one of the following to the first TCS via the connection:
   a software image and all associated configuration data; or
   an indication of a trusted location from which the selected TCS can obtain a software image and all associated configuration data.

B1. A method performed by a service provider (SP) of trusted computing services (TCS), the method comprising:
sending, to a remote service database, the following information related to each of one or more TCS available from the SP:
   an identifier of the available TCS;
   identification of software used to provide the available TCS; and
   one or more indicia of trust for a computing platform used to provide the available TCS; and
receiving, from a computing device, an indication of selection of one of the available TCS by a user of the computing device or by an application executing on the computing device, and establishing a connection with the computing device.

B2. The method of embodiment B1, wherein the identification of software for each available TCS includes one of the following:
a hash value of a software image and of all associated configuration data; or
an indication of a third party that can sign a statement that a particular software image and configuration data is acceptable for the available TCS.

B3. The method of any of embodiments B1-B2, wherein for each available TCS:
the identifier of the available TCS includes a human-readable service name; and
the identification of the software includes a location from which the software can be obtained.

B4. The method of any of embodiments B1-B3, wherein the indicia of trust for each available TCS include one or more of the following:
roots of trust from a manufacturer of CPUs used to provide the available TCS;
one or more types of computing technology used to provide the available TCS; and
features that are enabled or disabled in the computing platform used to provide the available TCS.

B5. The method of embodiment B4, wherein the one or more types of computing technology include any of the following:
Intel Software Guard eXtensions (SGX),
AMD Secure Encrypted Virtualization (SEV), and
ARM TrustZone.

B6. The method of any of embodiments B1-B5, wherein information sent to the remote service database also includes one of the following for each available TCS:
an indication that the available TCS can only be single-user;
an indication that the available TCS can only be multi-user; or
an indication that the available TCS can be single-user or multi-user.

B7. The method of any of embodiments B1-B6, wherein:
receiving the indication of a selection is via a first address; and
the method further comprises:
   when an instance of the selected TCS is already running on the computing platform and a load level of the already-running instance is below a threshold, assigning the user computing device to the already-running instance;
   otherwise, initiating an instance of the selected TCS and assigning the user computing device to the initiated instance; and
   redirecting the connection from the first address to a second address associated with the assigned instance of the selected TCS.

B8. The method of any of embodiments B1-B7, wherein the remote service database is associated with a domain name and a domain name service (DNS) resolver.

B9. The method of any of embodiments B1-B8, further comprising:
providing, by the selected TCS to the computing device via the connection, a cryptographic attestation of at least one of the following used for the selected TCS: software and computing platform; and
providing the selected TCS to the computing device via the software and the computing platform associated with the attestation.

B10. The method of embodiment B9, further comprising providing, by the selected TCS to the user computing device via the connection, third-party information associated with the software used for the selected TCS.

B11. The method of embodiment B10, wherein the third-party information is a digital signature indicating that a particular version of the software is acceptable for the selected TCS.

B12. The method of embodiment B9, wherein the information related to a first TCS, of the available TCS, that is sent to the remote service database includes:
an indication that the first TCS is willing to run any user-provided software; and
trusted computing parameters associated with a computing platform used to run any user-provided software.

B13. The method of embodiment B12, wherein:
the selected TCS is the first TCS; and
the method further comprises obtaining a software image and all associated configuration data for the software used for the first TCS from one of the following:
   directly from the user computing device via the connection; or
   from a trusted location indicated by the user computing device.

B14. The method of embodiment B13, wherein the cryptographic attestation is based on the obtained software image and all associated configuration data.

C1. A method performed by a service database of trusted computing services (TCS) to match required TCS to available TCS, the method comprising:
receiving, from a plurality of service providers (SPs), the following information related to each of one or more TCS available from each of the SPs:
   an identifier of the available TCS;
   identification of software used to provide the available TCS; and
   one or more indicia of trust for a computing platform used to provide the available TCS;
storing the information from the SPs in the service database;
receiving a query for one or more TCS required by a user of a computing device or by an application executing on the computing device, wherein the query for each of the required TCS includes:
   identification of software required to provide the required TCS, and
   one or more indicia of trust for any computing platform that provides the required TCS;
identifying, from the stored information, one or more available TCS that corresponds to the information provided with the query; and
sending, to the computing device in response to the query, an indication of the identified available TCS and corresponding (SPs of the identified available TCS.

C2. The method of embodiment C1, wherein the identification of software in the query for each required TCS includes one of the following:
a hash value of a software image and of all associated configuration data; or
an indication of a third party that can sign a statement that a particular software image and configuration data is acceptable for the required TCS.

C3. The method of any of embodiments C1-C3, wherein:
the query for each required TCS includes a human-readable service name associated with the required TCS; and
the identification of software in the query for each required TCS includes a location from which the software can be obtained.

C4. The method of any of embodiments C1-C3, wherein the indicia of trust in the query for each required TCS include one or more of the following:
roots of trust from a manufacturer of CPUs trusted to perform the required TCS;
one or more types of computing technology trusted to perform the required TCS;
one or more types of computing technology not trusted to perform the required TCS; and
features that must be enabled or disabled for trusting a computing platform to perform the required TCS.

C5. The method of embodiment C4, wherein the one or more types of computing technology include any of the following:
Intel Software Guard eXtensions (SGX),
AMD Secure Encrypted Virtualization (SEV), and
ARM TrustZone.

C6. The method of any of embodiments C1-C5, wherein the query for each required TCS includes one of the following:
a requirement for the required TCS to be single-user;
a requirement for the required TCS to be multi-user; or
an indication that the required TCS can be single-user or multi-user.

C7. The method of any of embodiments C1-C6, wherein the remote service database is associated with a domain name and a domain name service (DNS) resolver.

C8. The method of any of embodiments C1-C7, wherein the identification of software for each available TCS includes one of the following:
a hash value of a software image and of all associated configuration data; or
an indication of a third party that can sign a statement that a particular software image and configuration data is acceptable for the available TCS.

C9. The method of any of embodiments C1-C7, wherein for each available TCS:
the identifier of the available TCS includes a human-readable service name; and
the identification of the software includes a location from which the software can be obtained.

C10. The method of any of embodiments C1-C9, wherein the indicia of trust for each available TCS include one or more of the following:
roots of trust from a manufacturer of CPUs used to provide the available TCS;
one or more types of computing technology used to provide the available TCS; and
features that are enabled or disabled in the computing platform used to provide the available TCS.

C11. The method of embodiment C10, wherein the one or more types of computing technology include any of the following:
Intel Software Guard eXtensions (SGX),
AMD Secure Encrypted Virtualization (SEV), and
ARM TrustZone.

C12. The method of any of embodiments C1-C11, wherein the received information related to each of the available TCS includes one of the following:
an indication that the available TCS can only be single-user;
an indication that the available TCS can only be multi-user; or
an indication that the available TCS can be single-user or multi-user.

D1. A computing device configured to obtain trusted computing services (TCS) from service providers (SP), the computing device comprising:
communication interface circuitry configured to communicate with a remote service database of TCS and with SPs of TCS identified in the remote service database; and
processing circuitry operably coupled to the communication interface circuitry, whereby the processing circuitry and communication circuitry are configured to perform operations corresponding to any of the methods of embodiments A1-A15.

D2. A computing device configured to obtain trusted computing services (TCS) from service providers (SP), the computing device being further configured to perform operations corresponding to any of the methods of embodiments A1-A15.

D3. A non-transitory, computer-readable medium storing computer-executable instructions that, when executed by processing circuitry of a computing device configured to obtain trusted computing services (TCS) from service providers (SP), configure the computing device to perform operations corresponding to any of the methods of embodiments A1-A15.

D4. A computer program product comprising computer-executable instructions that, when executed by processing circuitry of a computing device configured to obtain trusted computing services (TCS) from service providers (SP), configure the computing device to perform operations corresponding to any of the methods of embodiments A1-A15.

E1. A computing platform of a service provider (SP) of trusted computing services (TCS), the computing platform comprising:
communication interface circuitry configured to communicate with a remote service database of TCS and with computing devices configured to use TCS provided by the computing platform; and
processing circuitry operably coupled to the communication interface circuitry, whereby the processing circuitry and communication interface circuitry are configured to perform operations corresponding to any of the methods of embodiments B1-B14.

E2. A computing platform of a service provider (SP) of trusted computing services (TCS), the computing platform being configured to perform operations corresponding to any of the methods of embodiments B1-B14.

E3. A non-transitory, computer-readable medium storing computer-executable instructions that, when executed by processing circuitry of a computing platform of a service provider (SP) of trusted computing services (TCS), configure the computing platform to perform operations corresponding to any of the methods of embodiments B1-B14.

E4. A computer program product comprising computer-executable instructions that, when executed by processing circuitry of a computing platform of a service provider (SP) of trusted computing services (TCS), configure the computing platform to perform operations corresponding to any of the methods of embodiments B1-B14.

F1. A service database of trusted computing services (TCS), the service database being configured to match required TCS to available TCS and comprising:
communication interface circuitry configured to communicate with remote computing devices configured to use TCS and with remote service providers (SPs) of available TCS;
a non-transitory, computer-readable medium configured to store information related to available TCS; and
processing circuitry operably coupled to the communication interface circuitry and the computer-readable medium, whereby the processing circuitry and communication interface circuitry are configured to perform operations corresponding to any of the methods of embodiments C1-C12.

F2. A service database of trusted computing services (TCS), the service database being configured to match required TCS to available TCS and being further configured to perform operations corresponding to any of the methods of embodiments C1-C12.

F3. A non-transitory, computer-readable medium storing computer-executable instructions that, when executed by processing circuitry associated with a service database of trusted computing services (TCS), configure the service database to perform operations corresponding to any of the methods of embodiments C1-C12.

F4. A computer program product comprising computer-executable instructions that, when executed by processing circuitry associated with a service database of trusted computing services (TCS), configure the service database to perform operations corresponding to any of the methods of embodiments C1-C12.

1.-53. (canceled)

54. A method performed by a computing device to obtain trusted computing services (TCS), from service providers (SPs), the method comprising:
querying one or more remote service databases for one or more TCS required by a user of the computing device or by an application executing on the computing device, wherein the query for each of the required TCS includes the following:
identification of software required to provide the required TCS, and
one or more indicia of trust for any computing platform that provides the required TCS;
receiving, from the one or more remote service databases, information related to one or more available TCS and corresponding SPs of the available TCS; and
based on the received information, selecting one of the available TCS and establishing a connection with the SP corresponding to the selected TCS.

55. The method of claim 54, wherein the identification of software in the query for each required TCS includes one of the following:
a hash value of a software image and of all associated configuration data; or
an indication of a third party that can sign a statement that a particular software image and configuration data is acceptable for the required TCS.

56. The method of claim 54, wherein:
the query for each required TCS includes a human-readable service name associated with the required TCS; and
the identification of software in the query for each required TCS includes a location from which the software can be obtained.

57. The method of claim 54, wherein the indicia of trust in the query for each TCS include one or more of the following:
roots of trust from a manufacturer of CPUs trusted to perform the TCS;
one or more types of computing technology trusted to perform the TCS;
one or more types of computing technology not trusted to perform the TCS; and
features that must be enabled or disabled for trusting a computing platform to perform the TCS.

58. The method of claim 54, wherein the query for each required TCS includes one of the following:
a requirement for the required TCS to be single-user;
a requirement for the required TCS to be multi-user; or
an indication that the required TCS can be single-user or multi-user.

59. The method of claim 54, further comprising:
querying one or more first remote databases for information concerning further remote databases of available TCS; and
receiving, from the one or more first databases, addresses of the one or more remote service databases.

60. The method of claim 54, further comprising:
receiving, from the selected TCS via the connection, a cryptographic attestation associated with software and/or computing platform used for the selected TCS; and
based on verifying the cryptographic attestation is valid and meets requirements provided in the query, obtaining the selected TCS via the software and/or the computing platform associated with the cryptographic attestation.

61. The method of claim 60, wherein:
the method further comprises receiving, from the selected TCS, a digital signature indicating that a particular version of the software is acceptable for the selected TCS; and
obtaining the selected TCS is also based on verifying that the third party is trusted and the digital signature is valid.

62. The method of claim 60, wherein:
the received information related to a first TCS of the available TCS includes an indication that the first TCS is willing to run any user-provided software; and
selecting one of the available TCS and establishing a connection with the SP corresponding to the selected TCS comprises:
selecting the first TCS based on the indication that the first TCS is willing to run any user-provided software; and
sending one of the following to the first TCS via the connection:
a software image and all associated configuration data; or
an indication of a trusted location from which the selected TCS can obtain a software image and all associated configuration data.

63. A method performed by a service provider (SP) of trusted computing services (TCS), the method comprising:
sending, to a remote service database, the following information related to each of one or more TCS available from the SP:
an identifier of the available TCS;
identification of software used to provide the available TCS; and
one or more indicia of trust for a computing platform used to provide the available TCS; and
receiving, from a computing device, an indication of selection of one of the available TCS by a user of the computing device or by an application executing on the computing device, and establishing a connection with the computing device.

64. The method of claim 63, wherein the identification of software for each available TCS includes one of the following:
a hash value of a software image and of all associated configuration data; or
an indication of a third party that can sign a statement that a particular software image and configuration data is acceptable for the available TCS.

65. The method of claim 63, wherein for each available TCS:
the identifier of the available TCS includes a human-readable service name; and
the identification of the software includes a location from which the software can be obtained.

66. The method of claim 63, wherein the indicia of trust for each available TCS include one or more of the following:
roots of trust from a manufacturer of CPUs used to provide the available TCS;
one or more types of computing technology used to provide the available TCS; and
features that are enabled or disabled in the computing platform used to provide the available TCS.

67. The method of claim 63, wherein information sent to the remote service database also includes one of the following for each available TCS:
an indication that the available TCS can only be single-user;
an indication that the available TCS can only be multi-user; or
an indication that the available TCS can be single-user or multi-user.

68. The method of claim 63, wherein:
receiving the indication of a selection is via a first address; and
the method further comprises:
when an instance of the selected TCS is already running on the computing platform and a load level of the already-running instance is below a threshold, assigning the computing device to the already-running instance;
otherwise, initiating an instance of the selected TCS and assigning the computing device to the initiated instance; and
redirecting the connection from the first address to a second address associated with the assigned instance of the selected TCS.

69. The method of claim 63, further comprising:
providing, by the selected TCS to the computing device via the connection, a cryptographic attestation associated with software and/or computing platform used for the selected TCS; and
providing the selected TCS to the computing device via the software and/or the computing platform associated with the cryptographic attestation.

70. The method of claim 69, further comprising providing, by the selected TCS to the computing device via the connection, a digital signature indicating that a particular version of the software is acceptable for the selected TCS.

71. The method of claim 70, wherein:
the information related to a first TCS, of the available TCS, that is sent to the remote service database includes an indication that the first TCS is willing to run any user-provided software;
the selected TCS is the first TCS;
the method further comprises obtaining a software image and all associated configuration data for the software used for the first TCS from one of the following: directly from the computing device via the connection, or from a trusted location indicated by the computing device; and
the cryptographic attestation is based on the obtained software image and all associated configuration data.

72. A method performed by a service database of trusted computing services (TCS) to match required TCS to available TCS, the method comprising:
receiving, from a plurality of service providers (SPs), the following information related to each of one or more TCS available from each of the SPs:
an identifier of the available TCS;
identification of software used to provide the available TCS; and
one or more indicia of trust for a computing platform used to provide the available TCS;
storing the information from the SPs in the service database;
receiving a query for one or more TCS required by a user of a computing device or by an application executing on the computing device, wherein the query for each of the required TCS includes:
identification of software required to provide the required TCS, and
one or more indicia of trust for any computing platform that provides the required TCS;
identifying, from the stored information, one or more available TCS that corresponds to the information provided with the query; and
sending, to the computing device in response to the query, an indication of the identified available TCS and corresponding SPs of the identified available TCS.

73. The method of claim 72, wherein each identification of software used to provide an available TCS and each identification of software required to provide a required TCS includes one of the following:
a hash value of a software image and of all associated configuration data; or
an indication of a third party that can sign a statement that a particular software image and configuration data is acceptable for the required TCS.
